(19) United States
(12) Patent Application Publication
(10) Pub. No.: US 2023/0409025 A1
(43) Pub. Date: Dec. 21, 2023

(54) PROACTIVE SIMULATION-BASED REMOTE ASSISTANCE RESOLUTIONS

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/843,668

(22) Filed: Jun. 17, 2022

(51) Int. Cl. G05D 1/00

(52) U.S. Cl. CPC G05D 1/0011; G05D 1/0061; G05D 1/0088; G05D 2201/0212; G05D 2201/0213

(57) ABSTRACT

A method is described and includes generating at least one predicted remote assistance (RA) need scenario in connection with a ride service provided by an autonomous vehicle (AV), wherein the generating is performed prior to an actual occurrence of the predicted RA need scenario; presenting the at least one predicted RA need scenario to an RA system for resolution of the at least one predicted RA need scenario, wherein the resolution comprises the RA system providing an operational decision in connection with the presented at least one RA need scenario; and storing the operational decision in an RA instruction buffer.

### TECHNICAL FIELD OF THE DISCLOSURE

The present disclosure relates generally to rideshare services provided using autonomous vehicles and, more specifically, to techniques for providing proactive simulation-based remote assistance for autonomous vehicle-enabled rideshare services.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts.

FIG. 1 is a diagram illustrating an example autonomous vehicle according to some embodiments of the present disclosure.

FIG. 2 is a diagram illustrating an example fleet of autonomous vehicles according to some embodiments of the present disclosure.

FIG. 3 is a diagram illustrating an onboard computer according to some embodiments of the present disclosure.

FIG. 4 is a diagram illustrating a fleet management system according to some embodiments of the present disclosure.

FIGS. 5-6 are flowcharts illustrating example processes of local assistance system according to some embodiments of the present disclosure.

### DESCRIPTION OF EXAMPLE EMBODIMENTS OF THE DISCLOSURE

Overview

The systems, methods, and devices of this disclosure each have several innovative aspects, no single one of which is solely responsible for all of the desirable attributes disclosed herein. Details of one or more implementations of the subject matter described in this Specification are set forth in the description below and the accompanying drawings.

Given the numerous advantages of ride hail, rideshare, and delivery services (which services may be collectively and/or interchangeably referred to herein simply as “rideshare services” whether for a single user/passenger, multiple users/passengers, and/or one or more items for delivery) provided by autonomous vehicles, it is anticipated that autonomous vehicle rideshare services will soon become the ubiquitous choice for various user transportation and delivery needs, including but not limited to school commutes, airport transfers, long distance road trips, and grocery and restaurant deliveries, to name a few.

An autonomous vehicle may encounter difficult and/or long tail situations in the provision of rideshare services that may result in the vehicle becoming immobilized (or stuck) and/or unable to make a decision regarding how to proceed with driving (e.g., due to an inability to classify an object). In such cases, the autonomous vehicle may solicit assistance from a human operator located remotely from the vehicle (“remote assistance” or “RA”) to determine a safe course of action under the circumstances. Connectivity problems, operational difficulties (such as a limit on the number of remote operators available to respond to autonomous vehicle calls for remote assistance at a given time), and other issues may create situations in which remote assistance is not available in a timely and optimal manner. Such issues may result in the autonomous vehicle remaining immobilized for an unacceptable period of time, which may negatively impact traffic around the autonomous vehicle, encourage other drivers to overtake the autonomous vehicle, make a passenger within the autonomous vehicle feel unsafe, or lead to a heightened collision risk with the autonomous vehicle or between other traffic participants. Even in situations in which remote assistance is provided in an uninterrupted manner, the brief wait required for the RA operator to resolve the situation at hand may result in a noticeable disruption in the rideshare service and a reduction in a corresponding customer comfort score.

In accordance with features of embodiments described herein, a proactive remote assistance (PRA) system and techniques for providing proactive simulation-based remote assistance resolutions to autonomous vehicles enable the prediction of a situation or scenario in which remote assistance is likely to be needed and a resolution (in the form of an operational decision) to the situation be determined before (and whether) the situation ever actually occurs. In certain embodiments, the operational decision is provided by RA to the autonomous vehicle, where it may be stored in the autonomous vehicle's RA instruction buffer. In this manner, if and when the predicted situation does occur, the operational decision may be more quickly implemented by the autonomous vehicle (AV), thereby minimizing (and ideally totally eliminating) any perceived disruption in the rideshare service being provided.

In certain embodiments, in operation, one or more scenarios that are likely to occur and that will require remote assistance input may be predicted by the PRA system, e.g., based on sensor data, perception and planning data, and other data (e.g., simulation data), prior to their occurrence. The predicted scenarios are presented to the remote assistance operator (in a prioritized manner) and the RA operator provides feedback (in the form of an operational decision) to the autonomous vehicle in connection with each of the scenarios presented. If and when a scenario that requires remote assistance actually occurs, the PRA system can determine which, if any, of the predicted scenarios match the actual scenario to an acceptable level or degree and apply the corresponding operational decision stored in the RA instruction buffer of the autonomous vehicle. If none of the predicted scenarios match the actual scenario, an assessment of the actual scenario by the RA operator may be required. If one of the predicted scenarios is close to the actual scenario, but not close enough, an RA reassessment may be forced.

As will be appreciated by one skilled in the art, aspects of the present disclosure, in particular aspects of embodiments described herein, may be embodied in various manners (e.g., as a method, a system, an autonomous vehicle, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 110a-110e), such a collection may be referred to herein without the letters (e.g., as “110”).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y. The terms “substantially,” “close,” “approximately,” “near,” and “about,” generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

Example Autonomous Vehicle

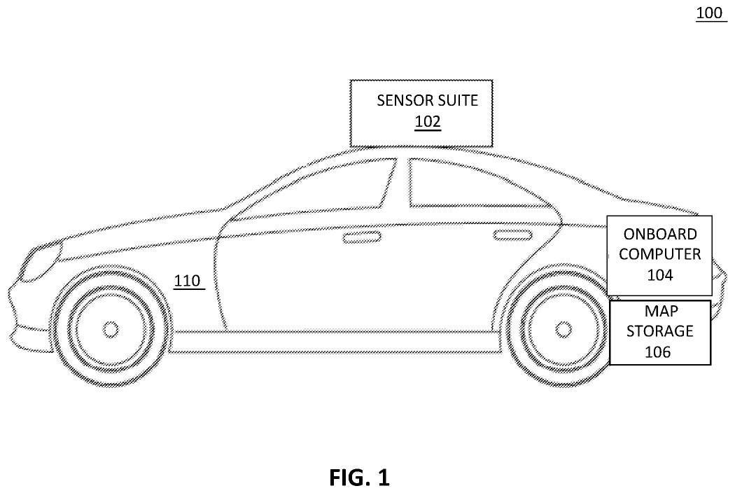

FIG. 1 is a diagram 100 illustrating an autonomous vehicle 110, according to some embodiments of the disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 may be part of a fleet of vehicles for picking up passengers and/or packages and driving to selected destinations. The autonomous vehicle 110 may be configured for ride management by an event host.

The sensor suite 102 includes localization and driving sensors. For example, the sensor suite may include one or more of photodetectors, cameras, radio detection and ranging (RADAR), SONAR, light detection and ranging (LIDAR), GPS, inertial measurement units (IMUS), accelerometers, microphones, strain gauges, pressure monitors, barometers, thermometers, altimeters, wheel speed sensors, and a CV system. The sensor suite 102 continuously monitors the autonomous vehicle's environment and, in some examples, sensor suite 102 data is used to detect selected events. In particular, data from the sensor suite can be used to update a map with information used to develop layers with waypoints identifying selected events, the locations of the encountered events, and the frequency with which the events are encountered at the identified location. In this way, sensor suite 102 data from many autonomous vehicles can continually provide feedback to the mapping system and the high-fidelity map can be updated as more and more information is gathered.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point-cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. Based upon the vehicle state and programmed instructions, the onboard computer 104 controls and/or modifies driving behavior of the autonomous vehicle 110.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general-purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

The autonomous vehicle 110 is preferably a fully autonomous automobile but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, an airplane, a bike, or a scooter. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

The autonomous vehicle 110 may include a map storage 106 for storing map data. The autonomous vehicle 110 may use the map data in various driving decisions, e.g., in finding optimal routes, in support of detecting objects along a route such as traffic lights, or for predicting behavior of other road users and planning autonomous vehicle behavior.

Example Autonomous Vehicle Fleet

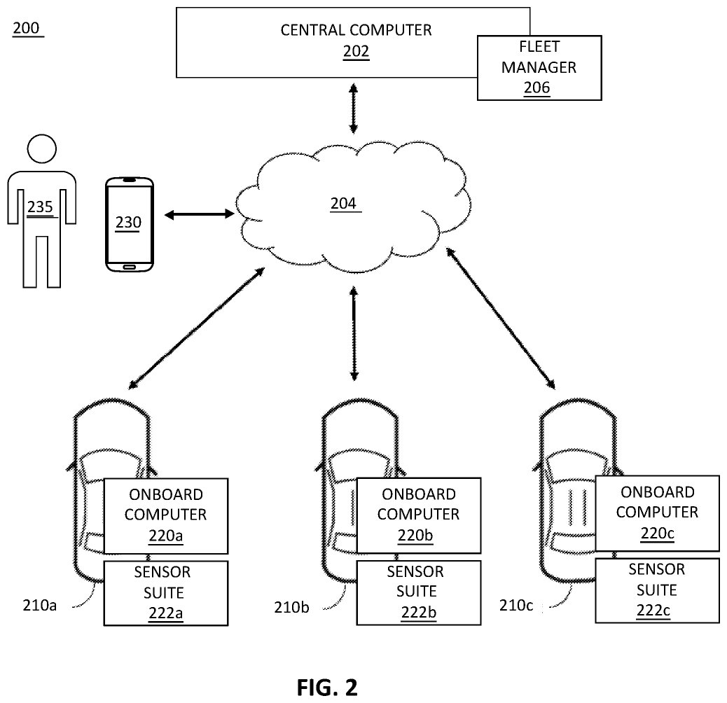

FIG. 2 is a diagram 200 illustrating a fleet of autonomous vehicles 210a, 210b, 210c in communication with a central computer 202 according to some embodiments of the disclosure. As shown in FIG. 2, the vehicles 210a-210c may communicate wirelessly with a central computer 202 and a cloud 204. The central computer 202 may include a fleet management system 206, which may include a routing coordinator and a database of information from the vehicles 210a-210c in the fleet. Each vehicle 210a-210c can include respective onboard computer 220a-220c and sensor suites 222a-222c, which can be similar to the onboard computer 104 and sensor suites 102 of FIG. 1.

The central computer 202 (and more particularly the fleet management system 206) may receive rideshare service requests for one of the autonomous vehicles 210 from user devices 230. Autonomous vehicle fleet routing refers to the routing of multiple vehicles in a fleet. In some implementations, autonomous vehicles communicate directly with each other. For example, a user 235 may make a request for rideshare service using a mobile app executing on the user device 230. The user device 230 may transmit the request directly to the fleet management system 206. The fleet management system 206 dispatches one of the autonomous vehicles 210a-210c to carry out the service request. When the dispatched one of the autonomous vehicles 210a-210c arrives at the pick-up location (i.e., the location at which the user is to meet the autonomous vehicle to begin the rideshare service), the user may be notified by the mobile app to meet the autonomous vehicle.

When a ride request is received from a passenger, the routing coordinator may select an autonomous vehicle 210a-210c to fulfill the ride request and generates a route for the autonomous vehicle 210a-210c. As described herein, in some examples, the routing coordinator selects more than one autonomous vehicle 210a-210c to fulfill the ride request. The generated route includes a route from the autonomous vehicle's present location to the pick-up location, and a route from the pick-up location to the final destination. In some examples, the generated route includes a route from the pick-up location to a selected waypoint, and a route from the selected waypoint to the final destination. In some examples, a first autonomous vehicle 210a drives the route to the waypoint and a second autonomous vehicle 210b drives the route from the waypoint to the final destination. In various examples, the route includes multiple waypoints and multiple autonomous vehicles. In some implementations, the central computer 202 communicates with a second fleet of autonomous vehicles, and a vehicle from the second fleet of autonomous vehicles drives the route from the waypoint to the final destination.

Each vehicle 210a-210c in the fleet of vehicles may communicate with a routing coordinator. Information gathered by various autonomous vehicles 210a-210c in the fleet can be saved and used to generate information for future routing determinations. For example, sensor data can be used to generate route determination parameters. In general, the information collected from the vehicles in the fleet can be used for route generation or to modify existing routes. In some examples, the routing coordinator collects and processes position data from multiple autonomous vehicles in real-time to avoid traffic and generate a fastest time route for each autonomous vehicle. In some implementations, the routing coordinator uses collected position data to generate a best route for an autonomous vehicle in view of one or more traveling preferences and/or routing goals.

The routing coordinator uses map data to select an autonomous vehicle from the fleet to fulfill a ride request. In some implementations, the routing coordinator sends the selected autonomous vehicle the ride request details, including pick-up location and destination location, and an onboard computer (e.g., onboard computer 220a, 220b, or 220c) on the selected autonomous vehicle generates a route and navigates to the destination. In some examples, the routing coordinator also sends the selected vehicle one or more stops, including a charging station stop, for the autonomous vehicle to recharge. In some examples, the routing coordinator sends a first vehicle the pick-up location and a waypoint location, and the routing coordinator sends a second vehicle the waypoint location and the destination location, such that the passenger switches vehicles mid-ride. In some implementations, the routing coordinator in the central computer 202 generates a route for each selected autonomous vehicle 210a-210c, and the routing coordinator determines a route for the autonomous vehicle 210a-210c to travel from the autonomous vehicle's current location to a first stop.

Central computer 202 may include a model trainer for training classification models used to classify objects by applying machine learning techniques to training data. Classification models may be downloaded to onboard computers 220a, 220b, 220c, for use in classifying objects encountered by the autonomous vehicle 210a, 210b, 210c.

Example Onboard Computer

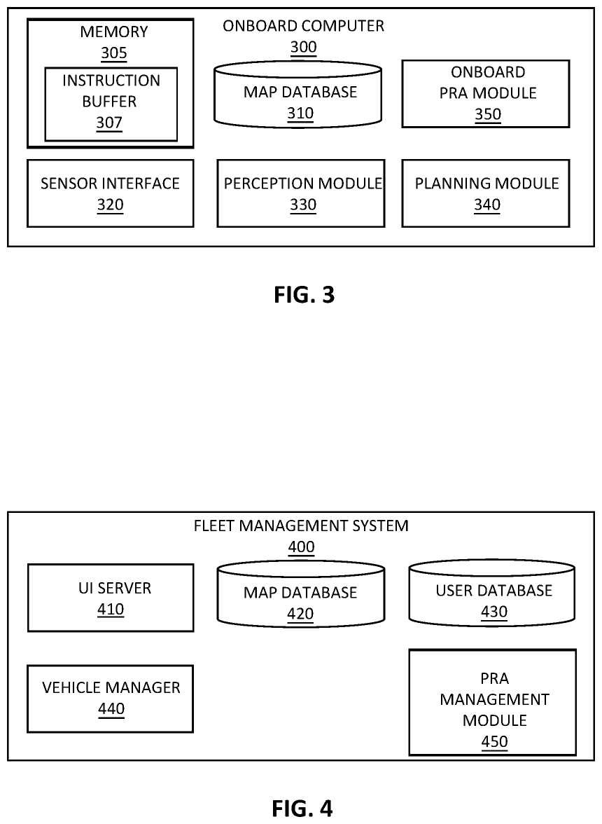

FIG. 3 is a block diagram illustrating an onboard computer 300, which may be used to implement onboard computer 104 (FIG. 1) and onboard computers 220 (FIG. 2) for enabling features according to some embodiments of the present disclosure. The onboard computer 300 may include memory 305, a map database 310, a sensor interface 320, a perception module 330, a planning module 340, and an onboard PRA module 350. In alternative configurations, fewer, different and/or additional components may be included in the onboard computer 300. For example, components and modules for controlling movements of the vehicles 110, 210, and other vehicle functions, and components and modules for communicating with other systems, such as central computer 202 and/or cloud 204, are not shown in FIG. 3. Further, functionality attributed to one component of the onboard computer 300 may be accomplished by a different component included in the onboard computer 300 or a different system from those illustrated.

The memory 305 stores any transient information that is used by the onboard computer 300. For example, memory 305 may comprise sensor data, perceptions produced by the perception module 330, and plans produced by the planning module 340. Memory 305 may comprise an instruction buffer 307 that stores previous instructions provided by an RA. The instruction buffer 307 may comprise a data structure that stores the time of the instruction, identifying information about the party who issued the instruction, and a description of the instruction.

The map database 310 stores a detailed map that includes a current environment of the vehicle. The map database 310 includes data describing roadways (e.g., locations of roadways, connections between roadways, roadway names, speed limits, traffic flow regulations, toll information, etc.) and data describing buildings (e.g., locations of buildings, building geometry, building types). The map database 310 may further include data describing other features, such as bike lanes, sidewalks, crosswalks, traffic lights, parking lots, etc.

The sensor interface 320 interfaces with the sensors in the sensor suite of the vehicle (e.g., sensor suite 140 (FIG. 1)). The sensor interface 320 may request data from the sensor suite, e.g., by requesting that a sensor capture data in a particular direction or at a particular time. The sensor interface 320 is configured to receive data captured by sensors of the sensor suite. The sensor interface 320 may have subcomponents for interfacing with individual sensors or groups of sensors of the sensor suite, such as a thermal sensor interface, a camera interface, a LIDAR interface, a RADAR interface, a microphone interface, etc.

The perception module 330 identifies objects in the environment of the vehicle. The sensor suite produces a data set that is processed by the perception module 330 to detect other cars, pedestrians, trees, bicycles, and objects traveling on or near a road on which the vehicle is traveling or stopped, and indications surrounding the vehicle (such as construction signs, traffic cones, traffic lights, stop indicators, and other street signs). For example, the data set from the sensor suite may include images obtained by cameras, point clouds obtained by LIDAR sensors, and data collected by RADAR sensors. The perception module 330 may include one or more classifiers trained using machine learning to identify particular objects. For example, a multi-class classifier may be used to classify each object in the environment of the vehicle as one of a set of potential objects, e.g., a vehicle, a pedestrian, or a cyclist. As another example, a human classifier recognizes humans in the environment of the vehicle, a vehicle classifier recognizes vehicles in the environment of the vehicle, etc.

The planning module 340 plans maneuvers for the vehicle based on map data retrieved from the map database 310, data received from the perception module 330, and navigation information, e.g., a route instructed by the fleet management system. In some embodiments, the planning module 340 receives map data from the map database 310 describing known, relatively fixed features and objects in the environment of the vehicle. For example, the map data includes data describing roads as well as buildings, bus stations, trees, fences, sidewalks, etc. The planning module 340 receives data from the perception module 330 describing at least some of the features described by the map data in the environment of the vehicle. The planning module 340 determines a pathway for the vehicle to follow. The pathway includes locations for the vehicle to maneuver to, and timing and/or speed of the vehicle in maneuvering to the locations.

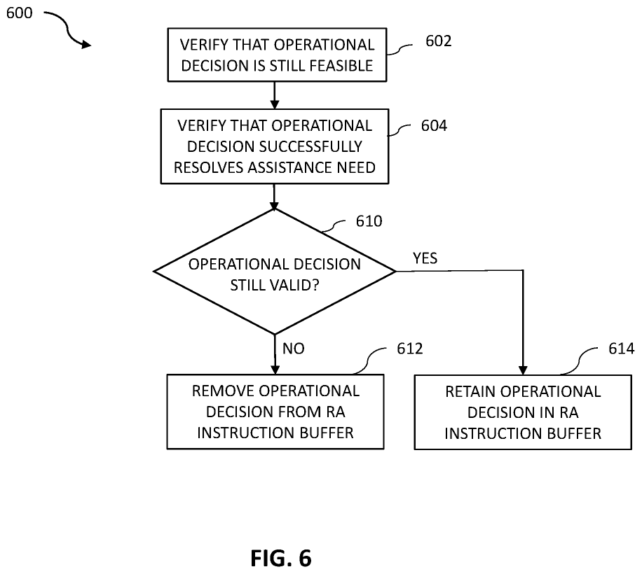

The onboard PRA module 350 may interact with other modules of the onboard computer 300 and other modules and systems to control and provide various aspects of the functionality and features of embodiments described herein and particularly as described below with reference to FIGS. 5-6.

Example Fleet Management System

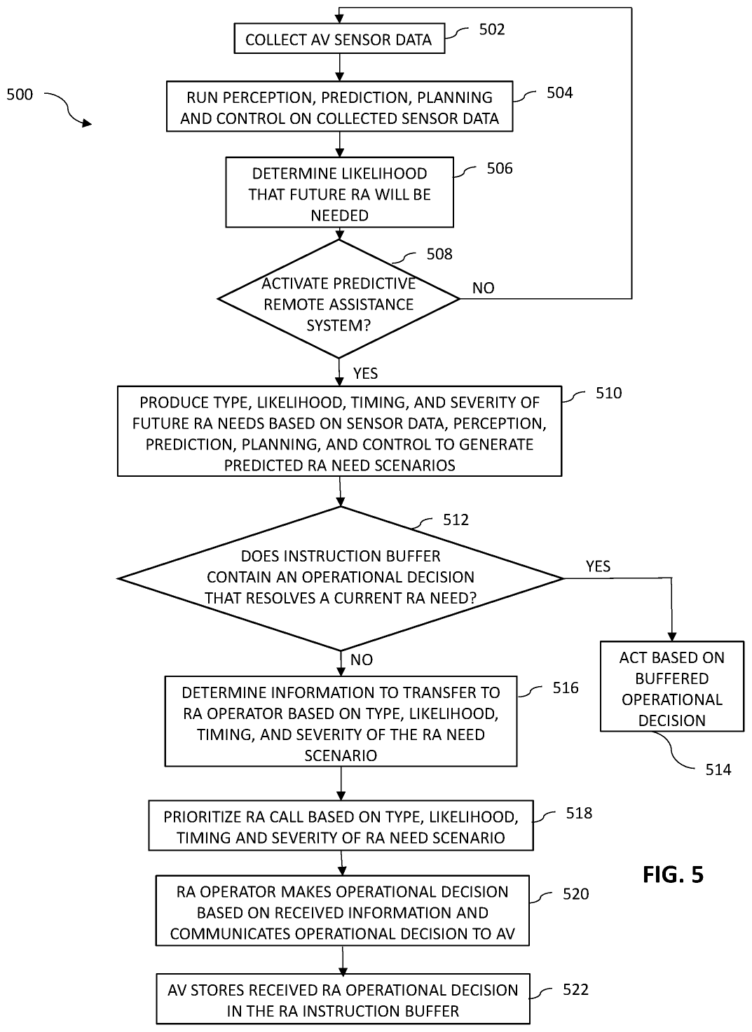

FIG. 4 is a block diagram illustrating a fleet management system 400, which may be implemented by central computer 202 (FIG. 2), according to some embodiments of the present disclosure. The fleet management system 400 includes a user interface (UI) server 410, a map database 420, a user database 430, a vehicle manager 440, and a PRA management module 450. In alternative configurations, different, additional, or fewer components may be included in the fleet management system 400. Further, functionality attributed to one component of the fleet management system 400 may be accomplished by a different component included in the fleet management system 400 or a different system than those illustrated.

The fleet management system 400 manages a fleet of autonomous vehicles, such as autonomous vehicle 110. The fleet management system 400 may manage one or more services that provide or use the autonomous vehicles, e.g., a service for providing rides to users with the autonomous vehicles, or a service that delivers items, such as prepared foods, groceries, or packages, using the autonomous vehicles. The fleet management system 400 may select an autonomous vehicle from the fleet of autonomous vehicles to perform a particular service or other task and instruct the selected autonomous vehicle to autonomously drive to a particular location (e.g., a designated pick-up location) to pick-up a user and/or drop off an order to a user. The fleet management system 400 may select a route for the autonomous vehicle to follow. The fleet management system 400 may also manage fleet maintenance tasks, such as charging, servicing, and cleaning of the autonomous vehicle. As illustrated in FIG. 2, the autonomous vehicles may communicate with the fleet management system 400. The autonomous vehicle and the fleet management system 400 may connect over a public network, such as the Internet.

The UI server 410 is configured to communicate with client devices that provide a user interface to users. For example, the UI server 410 may be a web server that provides a browser-based application to client devices, or the UI server 410 may be a user app server that interfaces with a user app installed on client devices. The UI enables the user to access a service of the fleet management system 400, e.g., to request a ride from an autonomous vehicle, or to request a delivery from an autonomous vehicle. For example, the UI server 410 receives a request for a ride that includes an origin location (e.g., the user's current location) and a destination location, or a request for a delivery that includes a pick-up location (e.g., a local restaurant) and a destination location (e.g., the user's home address).

The map database 420 stores a detailed map describing roads and other areas (e.g., parking lots, autonomous vehicle service facilities) traversed by a fleet of autonomous vehicles, such as vehicles 210 (FIG. 2). The map database 420 includes data describing roadways (e.g., locations of roadways, connections between roadways, roadway names, speed limits, traffic flow regulations, toll information, etc.), data describing buildings (e.g., locations of buildings, building geometry, building types), and data describing other objects (e.g., location, geometry, object type), and data describing other features, such as bike lanes, sidewalks, crosswalks, traffic lights, parking lots, etc. At least a portion of the data stored in the map database 420 is provided to onboard computers of vehicles in the fleet, such as onboard computer 300 (FIG. 3), as a map database 310 (FIG. 3), described above.

The user database 430 stores data describing users of the fleet of vehicles managed by fleet management system 400. Users may create accounts with the fleet management system 400, which stores user information associated with the user accounts, or user profiles, in the user database 430. The user information may include identifying information (name, username), password, payment information, home address, contact information (e.g., email and telephone number), and information for verifying the user (e.g., photograph, driver's license number). Users may provide some or all of the user information, including user preferences regarding certain aspects of services provided by the rideshare system, to the fleet management system 400. In some embodiments, the fleet management system 400 may infer some user information from usage data or obtain user information from other sources, such as public databases or licensed data sources.

The fleet management system 400 may learn one or more home addresses for a user based on various data sources and user interactions. The user may provide a home address when setting up his account, e.g., the user may input a home address, or the user may provide an address in conjunction with credit card information. In some cases, the user may have more than one home, or the user may not provide a home address, or the user-provided home address may not be correct (e.g., if the user moves and the home address is out of date, or if the user's address associated with the credit card information is not the user's home address). In such cases, the fleet management system 400 may obtain a home address from one or more alternate sources. In one example, the fleet management system 400 obtains an address associated with an official record related to a user, such as a record from a state licensing agency (e.g., an address on the user's driver's license), an address from the postal service, an address associated with a phone record, or other publicly available or licensed records. In another example, the fleet management system 400 infers a home address based on the user's use of a service provided by the fleet management system 400. For example, the fleet management system 400 identifies an address associated with at least a threshold number of previous rides provided to a user (e.g., at least 10 rides, at least 50% of rides, or a plurality of rides), or at least a threshold number of previous deliveries (e.g., at least five deliveries, at least 60% of deliveries) as a home address or candidate home address. The fleet management system 400 may look up a candidate home address in the map database 420 to determine if the candidate home address is associated with a residential building type, e.g., a single-family home, a condominium, or an apartment. The fleet management system 400 stores the identified home address in the user database 430. The fleet management system 400 may obtain or identify multiple addresses for a user and associate each address with the user in the user database 430. In some embodiments, the fleet management system 400 identifies a current home address from multiple candidate home addresses, e.g., the most recent address, or an address that the user rides to or from most frequently and flags the identified current home address in the user database 430.

The vehicle manager 440 directs the movements of the vehicles in the fleet managed by fleet management system 400 (e.g., vehicles 210 (FIG. 2)). The vehicle manager 440 receives service requests from users from the UI server 410, and the vehicle manager 440 assigns service requests to individual vehicles. For example, in response to a user request for transportation from an origin location to a destination location, the vehicle manager 440 selects a vehicle and instructs the vehicle to drive to the origin location (e.g., a passenger or delivery pick-up location), and then instructs the vehicle to drive to the destination location (e.g., the passenger or delivery destination location). In addition, the vehicle manager 440 may instruct vehicles to drive to other locations while not servicing a user, e.g., to improve geographic distribution of the fleet, to anticipate demand at particular locations, to drive to a charging station for charging, etc. The vehicle manager 440 also instructs vehicles to return to autonomous vehicle facilities for recharging, maintenance, or storage.

The PRA management module 450 may interact with other modules of the onboard computer 300 and the fleet management system 400 to manage and control various aspects of features and functionality of embodiments described herein and particularly as described below with reference to FIGS. 5-6.

Example Method for Proactive Remote Assistance Implementation and Operation

FIGS. 5-6 are flowcharts illustrating example processes for a PRA system for an autonomous vehicle rideshare service according to some embodiments of the present disclosure. One or more of the steps illustrated in FIGS. 5-6 may be executed by one or more of the elements shown in the preceding figures. In particular, one or more of the steps illustrated in FIGS. 5-6 may be implemented by the PRA module 350 (FIG. 3).

RA infrastructure may be used to resolve autonomous vehicle behavior in real world or simulations. In particular, RA infrastructure may be used for RA training as well as learning of the autonomous vehicle system. In accordance with features of embodiments described herein, the PRA system may predict situations that will likely require RA attention based on received autonomous vehicle sensor data, routing and planning data, and perception data inter alia. Simulations may be used for environmental data and for other actors. RA may be requested based on scenarios predicted by the PRA system (“predicted RA scenarios” or “predicted RA situations”) before a scenario requiring RA actually occurs (“real RA scenario” or “real RA situation”).

In operation, an RA operator may be presented with one or more predicted RA scenarios (generated by the PRA system based on data and simulations) and asked to provide operational decisions to resolve the predicted RA scenarios before such scenarios actually occur. The operational decisions will be provided to an RA instruction buffer (e.g., instruction buffer 307 (FIG. 3) of the autonomous vehicle and will be used in place of making an RA call if the predicted RA scenario (or a scenario similar enough to the predicted RA scenario) actually occurs. Additionally, in some embodiments, a risk calculation may be made to force a reassessment for the RA based on how much the real RA scenario differs from a corresponding predicted RA scenario. In one embodiment, real RA scenarios/requests will be prioritized over predicted RA scenarios/requests in order to optimize RA time and resources.

FIG. 5 is a flowchart illustrating an example method 500 for a PRA system for an autonomous vehicle rideshare service in accordance with features of embodiments described herein. One or more of the operations illustrated in FIG. 6 may be executed by or in connection with the PRA module 350 (FIG. 3).

In step 502, sensor data from the one or more sensors of a sensor suite of the autonomous vehicle is collected. In various embodiments, sensor data may include one or more of LIDAR data, camera data, CV data, and RADAR data.

In step 504, perception, prediction, planning, and control functions are executed on the collected sensor data (step 502) to determine scenarios that are likely to arise in connection with present and future operations of the autonomous vehicle, e.g., in connection with the present rideshare or other service being provided by the autonomous vehicle in an environment of the autonomous vehicle.

In step 506, a likelihood that the autonomous vehicle will need remote assistance in the near future is determined based on the processes executed in step 504. In accordance with features of embodiments described herein, a time frame that constitutes the “near future” may be based on a number of different factors, including availability of resources for making such predictions, the availability of RA resources, and an environment in which the autonomous vehicle is operating, for example. As an example, near future may be any time from 1 to 15 seconds from the present time into the future.

In step 508, a determination is made whether the PRA functionality should be activated based on the likelihood of the need for remote assistance. If a negative determination is made in step 508, execution returns to step 502; otherwise, execution proceeds to step 510.

In step 510, a type, likelihood, timing, and severity of future RA needs are produced based on sensor data, perception, prediction and planning, and control to generate predicted RA need scenarios. Such predicted RA need scenarios may include one or more of the following, for example:
1. RA is needed to enable a safe stop of the vehicle due to a latency budget violation (e.g., the latency of execution of a component in the onboard computer 300 exceeded a predetermined safety value);
2. RA is needed due to vehicle becoming stuck due to contradictory perception information (e.g., the perception module produces information that is not consistent temporally or is not feasible physically or there is a functionally significant mismatch between the perceptions of different sensors);
3. RA is needed due to vehicle becoming stuck due to a need to perform a maneuver that is higher risk than normally acceptable;
4. RA is needed for a Vehicle Retrieval Event (VRE) (e.g., the situation into which the autonomous vehicle falls is in a category of events that requires the autonomous vehicle to be physically retrieved);
5. RA is needed due to vehicle becoming stuck on a left turn with low visibility (e.g., the autonomous vehicle is unable to move for a period of time that makes the occupants unsafe, causes disruption to the traffic, or makes the autonomous vehicle operation inefficient);
6. RA is needed due to weather issues (e.g., a weather simulation or forecast may be used and a determination may be made based on the simulation or forecast that the weather is deteriorating (e.g., rain or snow) with increasing intensity);
7. RA is needed due to vehicle connectivity issues (e.g., the vehicle has experienced connectivity issues for a period of time that is deemed to be unsafe); and
8. RA is needed due to passenger behavior (e.g., onboard sensors detect passenger behavior that may be unsafe to the passenger, to others, or to the autonomous vehicle itself).
   It will be recognized that the above-scenarios are presented for example only and that occurrence of other RA need scenarios are possible and probable.

In step 512, in response to a current (or actual or real) RA need scenario, a determination is made whether the autonomous vehicle's instruction buffer (e.g., instruction buffer 307 (FIG. 3)) includes an operational decision that resolves the current RA need. It will be recognized that this determination may include performing a simulation or risk calculation to assess a risk involved in addressing the current RA need scenario incorrectly and/or addressing the current RA need using the buffered operational decision. Failure of the risk calculation may force a reassessment for the RA based on how much the current RA need scenario differs from the predicted RA need scenario. If a positive determination is made in step 512, execution proceeds to step 514. If a negative determination is made in step 512, execution proceeds to step 516. Additional details regarding execution of step 512 are provided below in connection with FIG. 6.

In step 514, the autonomous vehicle acts based on the buffered operational decision. In particular, the operational decision is implemented by the autonomous vehicle and/or the autonomous vehicle executes one or more actions as dictated by the operational decision.

In step 516, information to be transferred to a remote assistance operator is determined based on the type, likelihood, timing, and severity of the RA need scenario. For example, referring to the example types of RA need scenarios detailed above in connection with step 510, a different type, quality, and quantity of information may be necessary and/or useful to assist the RA operator in resolving of the types of scenarios versus another one of the types of scenarios.

In step 518, the RA call is prioritized based on the type, likelihood, timing, and severity of the RA need scenario. For example, in this step, actual RA need scenarios will always take priority over predicted RA need scenarios. With regard to prioritizing of predicted RA need scenarios, RA need scenarios that are more likely to happen, are likely to occur sooner, and/or or more severe will take priority over RA need scenarios that are less likely to happen, are likely to occur later, and/or are less severe. Additionally, certain types of predicted RA need scenarios will take priority over others.

In step 520, the RA operator makes an operational decision for the presented RA need scenario and communicates the operational decision to the vehicle.

In step 522, the autonomous vehicle stores the operational decision in the RA instruction buffer. In a case in which the received operational decision is for a current RA need scenario, the autonomous vehicle drives based on the received operational decision.

FIG. 6 is a flowchart illustrating an example method 600 for a PRA system for an autonomous vehicle rideshare service in accordance with features of embodiments described herein. In particular, the method 600 is an example method that may be implemented in step 512 of the method 500 (FIG. 5). Additionally, one or more of the operations illustrated in FIG. 6 may be executed by or in connection with the PRA module 350 (FIG. 3).

In step 602, the continued feasibility of the operational decision from the RA instruction buffer (e.g., instruction buffer 307 (FIG. 3)) with respect to the present RA need scenario is verified. In order to conduct the verification, a simulation of the autonomous vehicle behavior can be made by assuming that the instruction in the instruction buffer is taken, and the outcome can be checked against the RA need. The simulation may be rule-based or may involve vehicle kinematics and interaction with other objects on the road.

In step 604, that the operational decision from the RA instruction buffer successfully resolves the present RA need is verified. The comparison may be conducted against the original RA need. This may comprise checking if the specific original RA need is still present in the simulated results. The PRA module 350 may also check for any changes in the margin between having a RA need and not having the RA need, and act based on any perceived deterioration. For example, if the RA need is addressed, but the situation is deteriorating into not addressing the RA need, the PRA module 350 may make an invalid operational decision determination.

In step 610, a decision is made whether, based on results of steps 602-608, the operational decision from the RA instruction buffer is still valid. If a positive decision is made in step 610, execution proceeds to step 612; otherwise, execution proceeds to step 614.

In step 612, the operational decision is removed form the RA instruction buffer as no longer being valid. This may coincide with, for example, the likelihood that the predicted RA need scenario with which the operational decision is connected dropping below a threshold level (i.e., the predicted RA need scenario is no longer likely to actually occur). Another example of a situation in which an operational decision may be removed from the instruction buffer would be a case in which the operational decision can no longer be safely executed by the autonomous vehicle. Yet another example situation in which an operational decision may be removed form the instruction buffer would be a case in which the operational decision times out.

In step 614, the operational decision is retained in the RA instruction buffer as a valid operational decision.

Although the operations of the example methods shown in FIGS. 5-6 are illustrated as occurring once each and in a particular order, it will be recognized that the operations may be performed in any suitable order and repeated as desired. Additionally, one or more operations may be performed in parallel. Furthermore, the operations illustrated in FIGS. 5-6 may be combined or may include more or fewer details than described.

### SELECT EXAMPLES

Example 1 provides a method, including generating at least one predicted remote assistance (RA) need scenario in connection with a ride service provided by an autonomous vehicle (AV), wherein the generating is performed prior to an actual occurrence of the predicted RA need scenario; presenting the at least one predicted RA need scenario to an RA system for resolution of the at least one predicted RA need scenario, wherein the resolution comprises the RA system providing an operational decision in connection with the presented at least one RA need scenario; and storing the operational decision in an RA instruction buffer.
Example 2 provides the method of example 1, further including, subsequent to an actual RA need scenario arising in connection with the ride service, comparing the actual RA need scenario with the at least one predicted RA need scenario; and, if the actual RA scenario matches the at least one predicted RA need scenario to an acceptable level, causing the AV to execute the operational decision stored in the RA instruction buffer.
Example 3 provides the method of any of examples 1-2, further including, if the actual RA scenario fails to match the at least one predicted RA need scenario to an acceptable level, presenting the actual RA need scenario to the RA system.
Example 4 provides the method of any of examples 1-3, further including prioritizing the presenting based on at least one characteristic of the predicted RA need scenario.
Example 5 provides the method of example 4, wherein the at least one characteristic comprises at least one of a type of the predicted RA need scenario, a likelihood that the predicted RA need scenario will develop into an actual RA need scenario; an amount of time estimated to transpire before the predicted RA need scenario will develop into an actual RA need scenario; and a severity of the RA need corresponding to the predicted RA need scenario.
Example 6 provides the method of any of examples 1-5, wherein the generating further comprises collecting sensor data from the AV.
Example 7 provides the method of example 6, wherein the generating further comprises running a simulation in connection with the collected sensor data.
Example 8 provides the method of example 6, wherein the generating further comprises running at least one of a perception process, a prediction process, a planning process, and a control process in connection with the collected sensor data.
Example 9 provides the method of any of examples 1-8, further including determining a likelihood that the predicted RA need scenario will actually occur prior to the presenting and, if the likelihood is below a predetermined threshold, abstaining from the presenting.
Example 10 provides a method including detecting an actual remote assistance (RA) need scenario in connection with a ride service provided by an autonomous vehicle (AV); determining whether the detected actual RA need scenario matches a predicted RA need scenario to an acceptable degree; and, if the actual RA scenario matches the predicted RA need scenario to an acceptable degree, causing the AV to execute an operational decision previously provided in connection with the predicted RA need scenario.
Example 11 provides the method of example 10, wherein the operational decision is stored in an RA instruction buffer of the AV.
Example 12 provides the method of any of examples 10-11, further including, prior to the causing the AV to execute an operational decision previously provided in connection with the predicted RA need scenario, verifying whether the operational decision is still valid.
Example 13 provides the method of example 12, wherein the verifying comprises at least one of verifying that execution of the operational decision by the AV is feasible; and verifying that execution of the operational decision by the AV resolves the actual RA need scenario.
Example 14 provides the method of example 13, wherein the verifying is performed using at least one of an AV prediction process and an AV planning process.
Example 15 provides the method of any of examples 12-14, wherein, if the operational decision is not still valid, removing the operational decision from the RA instruction buffer.
Example 16 provides a system including a vehicle comprising at least one onboard sensor for generating sensor data representative of an environment of the vehicle; and a proactive remote assistance (PRA) module configured to generate at least one predicted remote assistance (RA) need scenario in connection with a ride service provided by a vehicle, wherein the generating is performed using the generated sensor data prior to an actual occurrence of the predicted RA need scenario; present the at least one predicted RA need scenario to an RA system for resolution of the at least one predicted RA need scenario, wherein the resolution comprises the RA system providing an operational decision in connection with the presented at least one RA need scenario; and store the operational decision in an RA instruction buffer of the vehicle.
Example 17 provides the system of example 16, wherein the PRA module is further configured to, subsequent to an actual RA need scenario arising in connection with the ride service, compare the actual RA need scenario with the at least one predicted RA need scenario; and, if the actual RA scenario matches the at least one predicted RA need scenario to an acceptable level, cause the AV to execute the operational decision stored in the RA instruction buffer.
Example 18 provides the system of example 17, wherein the PRA module is further configured to present the actual RA need scenario to the RA system if the actual RA scenario fails to match the at least one predicted RA need scenario to an acceptable level.
Example 19 provides the system of any of examples 16-18, wherein the PRA module is further configured to prioritize the presenting based on at least one characteristic of the predicted RA need scenario.
Example 20 provides system of example 19, wherein the at least one characteristic comprises at least one of a type of the predicted RA need scenario, a likelihood that the predicted RA need scenario will develop into an actual RA need scenario; an amount of time estimated to transpire before the predicted RA need scenario will develop into an actual RA need scenario; and a severity of the RA need corresponding to the predicted RA need scenario.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words “means for” or “step for” are specifically used in the particular examples; and (b) does not intend, by any statement in the Specification, to limit this disclosure in any way that is not otherwise reflected in the appended examples.

What is claimed is:

1. A method comprising:
generating at least one predicted remote assistance (RA) need scenario in connection with a ride service provided by a vehicle, wherein the generating is performed prior to an actual occurrence of the predicted RA need scenario;
presenting the at least one predicted RA need scenario to an RA system for resolution of the at least one predicted RA need scenario, wherein the resolution comprises the RA system providing an operational decision in connection with the presented at least one RA need scenario; and
storing the operational decision in an RA instruction buffer.

2. The method of claim 1, further comprising:
subsequent to an actual RA need scenario arising in connection with the ride service, comparing the actual RA need scenario with the at least one predicted RA need scenario; and
if the actual RA scenario matches the at least one predicted RA need scenario to an acceptable level, causing the vehicle to execute the operational decision stored in the RA instruction buffer.

3. The method of claim 2, further comprising, if the actual RA scenario fails to match the at least one predicted RA need scenario to an acceptable level, presenting the actual RA need scenario to the RA system.

4. The method of claim 1, further comprising prioritizing the presenting based on at least one characteristic of the predicted RA need scenario.

5. The method of claim 4, wherein the at least one characteristic comprises at least one of a type of the predicted RA need scenario, a likelihood that the predicted RA need scenario will develop into an actual RA need scenario; an amount of time estimated to transpire before the predicted RA need scenario will develop into an actual RA need scenario; and a severity of the RA need corresponding to the predicted RA need scenario.

6. The method of claim 1, wherein the generating further comprises collecting sensor data from the vehicle.

7. The method of claim 6, wherein the generating further comprises running a simulation in connection with the collected sensor data.

8. The method of claim 6, wherein the generating further comprises running at least one of a perception process, a prediction process, a planning process, and a control process in connection with the collected sensor data.

9. The method of claim 1, further comprising determining a likelihood that the predicted RA need scenario will actually occur prior to the presenting and, if the likelihood is below a predetermined threshold, abstaining from the presenting.

10. A method comprising:
detecting an actual remote assistance (RA) need scenario in connection with a ride service provided by a vehicle;
determining whether the detected actual RA need scenario matches a predicted RA need scenario to an acceptable degree; and
if the actual RA scenario matches the predicted RA need scenario to an acceptable degree, causing the vehicle to execute an operational decision previously provided in connection with the predicted RA need scenario.

11. The method of claim 10, wherein the operational decision is stored in an RA instruction buffer of the vehicle.

12. The method of claim 10, further comprising, prior to the causing the vehicle to execute an operational decision previously provided in connection with the predicted RA need scenario, verifying whether the operational decision is still valid.

13. The method of claim 12, wherein the verifying comprises at least one of:
verifying that execution of the operational decision by the vehicle is feasible; and
verifying that execution of the operational decision by the vehicle resolves the actual RA need scenario.

14. The method of claim 13, wherein the verifying is performed using at least one of a vehicle prediction process and a vehicle planning process.

15. The method of claim 12, wherein, if the operational decision is not still valid, removing the operational decision from the RA instruction buffer.

16. A system comprising:
a vehicle comprising at least one onboard sensor for generating sensor data representative of an environment of the vehicle; and
a predictive remote assistance (PRA) module configured to:
generate at least one predicted remote assistance (RA) need scenario in connection with a ride service provided by the vehicle, wherein the generating is performed using the generated sensor data prior to an actual occurrence of the predicted RA need scenario;
present the at least one predicted RA need scenario to an RA system for resolution of the at least one predicted RA need scenario, wherein the resolution comprises the RA system providing an operational decision in connection with the presented at least one RA need scenario; and
store the operational decision in an RA instruction buffer of the vehicle.

17. The system of claim 16, wherein the PRA module is further configured to:
subsequent to an actual RA need scenario arising in connection with the ride service, compare the actual RA need scenario with the at least one predicted RA need scenario; and
if the actual RA scenario matches the at least one predicted RA need scenario to an acceptable level, cause the vehicle to execute the operational decision stored in the RA instruction buffer.

18. The system of claim 17, wherein the PRA module is further configured to present the actual RA need scenario to the RA system if the actual RA scenario fails to match the at least one predicted RA need scenario to an acceptable level.

19. The system of claim 16, wherein the PRA module is further configured to prioritize the presenting based on at least one characteristic of the predicted RA need scenario.

20. The system of claim 19, wherein the at least one characteristic comprises at least one of a type of the predicted RA need scenario, a likelihood that the predicted RA need scenario will develop into an actual RA need scenario; an amount of time estimated to transpire before the predicted RA need scenario will develop into an actual RA need scenario; and a severity of the RA need corresponding to the predicted RA need scenario.
